(19) United States
(12) Patent Application Publication
(10) Pub. No.: US 2009/0320511 A1
(43) Pub. Date: Dec. 31, 2009

(54) Ice dispenser

(75) Inventors: Martin Buchstab, Bopfingen (DE); Irene Dumkow, Sontheim (DE); Adolf Feinauer, Giengen (DE); Klaus Flinner, Zoschingen (DE); Bernd Heger, Haunsheim (DE); Peter Nalbach, Kirchheim/Nabern (DE); Kasim Yazan, Ulm (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/310,758

(22) PCT Filed: Aug. 8, 2007
(86) PCT No.: PCT/EP2007/058232

§ 371 Date: Mar. 6, 2009

(30) Foreign Application Priority Data
Sep. 7, 2006 (DE) 20 2006 013 709.2

(51) Int. Cl. F25C 5/02; F25C 5/18; B02C 18/14; G01F 11/20

(52) U.S. Cl. 62/320; 62/344; 241/190; 222/240

(57) ABSTRACT

An ice dispenser including a storage compartment for ice cubes having a dispensing opening through which ice cubes can exit; and a slider movable over the dispensing opening along a predefined path, the slider including a first set of fingers and a module having a second set of fingers, with the first set of fingers being formed with at least two axially interspaced fingers delimiting therebetween an intermediate space, and during movement of the slider on the predefined path, a finger of the second set of fingers passes through the intermediate space, the module of the slider being movable between a partial covering position in which the module partially covers the dispensing opening and a release position in which the module does not cover the dispensing opening to the same extent as it covers the dispensing opening in its partial covering position.

The present invention relates to an ice dispenser, in particular an ice dispenser of the type that can be used in a refrigeration appliance, to store ice cubes produced by an automatic ice maker in the refrigeration appliance and dispense them at a user's request.

An ice dispenser known from U.S. Pat. No. 4,176,527 A comprises a storage compartment for ice cubes, a slider with a number of parallel blade-type interspaced fingers that can be rotated in a dispensing chamber of the storage compartment and a module with a second set of fingers, which can optionally be rotated with the slider or can be fixed to the storage compartment, to dispense either intact ice cubes or ice that has been crushed between the fingers of the slider and the module at a dispensing opening.

In the fixed state the second set of fingers divides the dispensing compartment into an upper and lower half, the dispensing opening being located on the lower half. To prevent intact ice cubes reaching the dispensing opening and being dispensed, when the module is fixed to produce crushed ice, the lower half of the dispensing chamber is isolated from the remainder of the storage compartment by a separating wall. In order to be dispensed, the ice must be lifted over this separating wall with the aid of a worm conveyor.

The slider and worm conveyor are arranged on an axis together with an agitator. The agitator is configured as a spiral, so that a rotation of the agitator causes ice cubes to be transported in the direction of the dispensing chamber. If the agitator were to be rotated but ice could not be dispensed from the dispensing chamber, the ice would congest in the dispensing chamber and block the rotation. It is therefore not possible for the agitator to rotate without ice being dispensed at the same time. If no ice is removed for quite a long period, there is a risk that the ice cubes in the storage compartment will freeze together and block the rotation, so that the ice dispenser has to be removed from the refrigeration appliance and defrosted before it can be used again.

To counter this risk, a very powerful drive motor can be provided for the agitator and the storage compartment and agitator can be designed to withstand a high level of mechanical loading, to allow ice cubes to be broken up even after quite a long period without use. This allows the risk of blocking of the ice dispenser to be reduced and the period without use after which a blockage occurs to be extended but this approach is associated with considerable cost and there is a risk of ice cubes being crushed in an unwanted manner in the storage compartment. However the greater the proportion of small fragments of ice in the storage compartment, the greater its tendency to freeze solid and therefore the greater the force required to break up the ice.

U.S. Pat. No. 4,846,381 proposes resolving the problem of freezing solid by arranging an agitator and a worm conveyor in the storage compartment of an ice dispenser separately, each being driven by its own motor. The agitator can thus be actuated to separate the ice cubes without the worm conveyor dispensing ice at the same time. One problem with this design is the large space requirement of the agitator and the separate worm conveyor and their drive motors, making this solution essentially of interest for commercial appliances serving solely to make ice.

The object of the present invention is to create an ice dispenser for the optional dispensing of ice cubes or crushed ice, which has a simple structure that can be achieved in a cost-effective manner, making it suitable in particular for deployment in a domestic refrigeration appliance.

The object is achieved in that in the case of an ice dispenser with a storage compartment for ice cubes, a slider that can be moved over a dispensing opening of the storage compartment on a predefined path and comprises a first set of fingers and a module comprising a second set of fingers, with at least one of the sets comprising at least two axially interspaced fingers, and during movement of the slider on the path one finger of the second set passes through an intermediate space between the two fingers of the first set, the module can be moved between a position in which it partially covers the dispensing opening and a position in which it releases the dispensing opening. The partial covering prevents intact ice cubes passing through the dispensing opening but allows crushed ice to be dispensed. It is therefore not necessary to create a dispensing chamber isolated from the remainder of the storage compartment by a separating wall and auxiliary means to transport the ice over the separating wall are also not required.

To improve the crushing action, the fingers are expediently configured as knives with sharp cutting edges.

A particularly simple structure is achieved, if one finger of the module is in the form of a plate and one edge of said plate bridges the dispensing opening in the position partially covering the dispensing opening. This means that the free cross-sectional surface of the dispensing opening is only reduced to an insignificant degree by the partial covering and the crushed ice can be dispensed efficiently. In particular if the module has a number of parallel plates, ice pushed between the plates by the fingers of the slider can be dispensed, without having to pass beforehand through an obstructive bottleneck or an edge.

The movement of the slider is expediently a rotational movement.

An agitator can be positioned in the storage compartment, its occasional actuation preventing the ice cubes stored in the storage compartment from freezing solid to one another.

A coupling is expediently arranged between the agitator and the slider to transmit or not to transmit a drive torque exerted on the agitator to the slider, as required. If the drive torque is transmitted, the slider rotates together with the agitator and ice cubes which come within range of the slider due to the movement or the agitator or in some other manner are transported by the slider to the dispensing opening. If the drive torque is not transmitted, the slider remains stationary, so that ice is not transported to the dispensing opening. In this state it is possible to actuate the agitator alone, to break up ice freezing together in the storage compartment without dispensing ice at the same time.

Because of its simple structure an ice dispenser is preferred, in which the agitator and slider have the same axis of rotation.

A particularly compact and simple structure is achieved, if the movement of the module between the two above-mentioned positions is a rotation about the axis of rotation of the slider.

Such a rotation can be driven in a simple manner, if the module is coupled to the slider in a friction-locked manner.

To allow the module to return to the bridging position, without having to provide a drive means for this purpose, it is advantageous if the bridging position is a stable equilibrium position of the module.

Further features and advantages of the invention will emerge from the description which follows of exemplary embodiments with reference to the accompanying figures, in which:

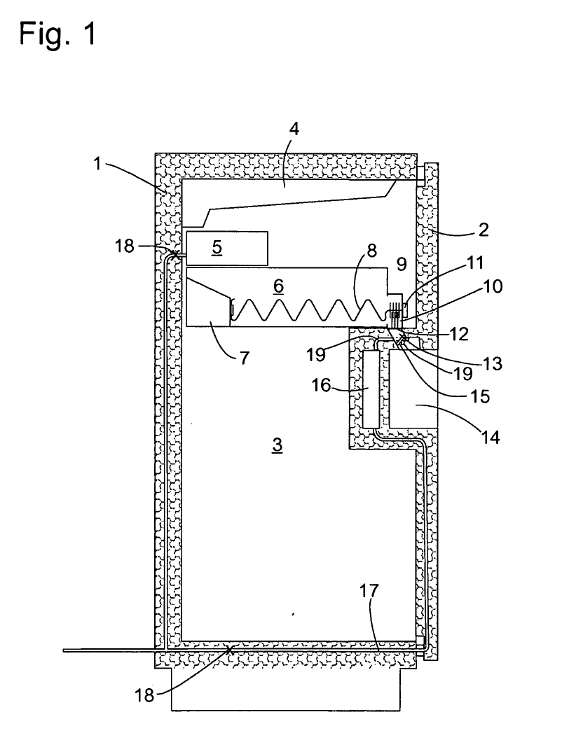

FIG. 1 shows a schematic section through a domestic refrigeration appliance, which is equipped with an inventive ice dispenser;

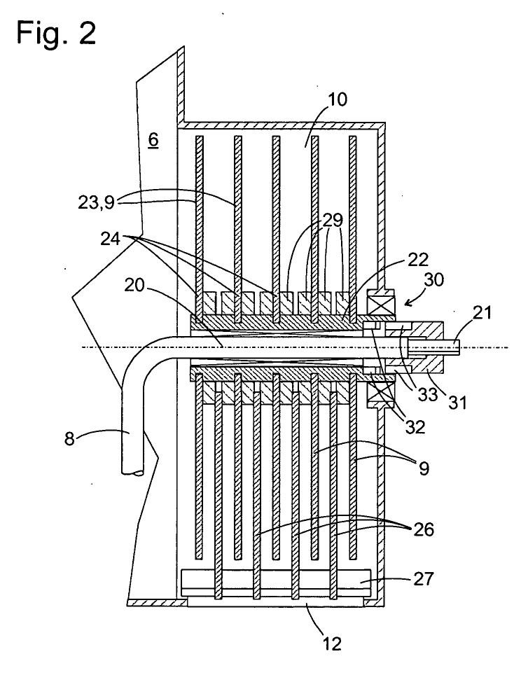

FIG. 2 shows an enlarged axial section through the dispensing chamber of the ice dispenser;

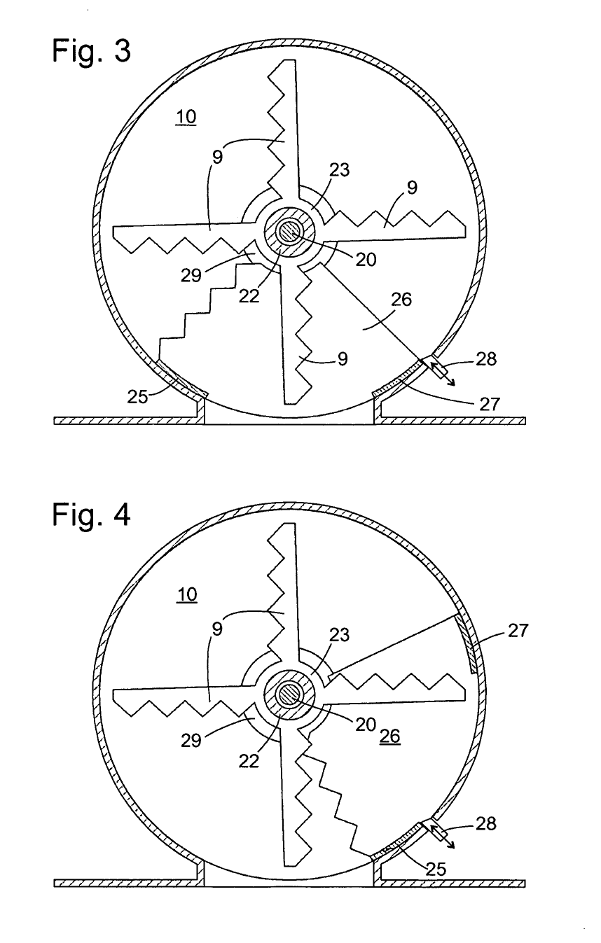

FIG. 3 shows a schematic section through the dispensing chamber perpendicular to the axis in an agitator operating mode or an operating mode for dispensing crushed ice; and

FIG. 4 shows a section like the one in FIG. 3 in an operating mode for dispensing ice cubes.

The refrigeration appliance shown in a schematic section in FIG. I has a thermally insulating body 1 and a door 2, which bound an interior 3. The interior 3 is kept at a temperature below 0° C. by an evaporator, which is housed in an evaporator chamber 4 isolated in the upper region of the body 1. An automatic ice maker 5 is arranged in the interior 3 in direct proximity to the evaporator chamber 4, so that it can preferably be acted on by cold air from the evaporator chamber 4. In a manner known per se (not shown in detail in the figure) the ice maker 5 comprises a number of mold trays, means for the automatic measuring of water into the mold trays and means for automatically ejecting the finished ice cubes from the mold trays.

A collector 6 of an ice dispenser is arranged below the ice maker 5, to receive the ejected ice cubes. The collector 6 extends over most of the depth of the interior 3. An electric motor is housed in a rear recess 7 of the collector 6 to drive an agitator rod 8 extending in the longitudinal direction of the collector 6. Rotating knives 9 of a grinding unit are coupled in a manner described in more detail below to an end 7 of the agitator rod 8 away from the recess. The knives 9 are housed in a cylindrical dispensing chamber 10, which is open toward the collector 6 and extends this along the axis of rotation of the agitator rod 8. An electromagnet 11 is arranged on an end wall of the dispensing chamber 10 facing toward the door 2, its function being described below.

The agitator rod 8 is a metal rod bent in a zigzag manner in a plane parallel to the axis. Its planar form means that, unlike a spiral or worm, it does not exert a transportation force in an axial direction on ice cubes contained in the collector 6 but moves these in random directions, thus preventing them freezing solid to one another to any significant degree. The agitator rod 8 can therefore be rotated from time to time by the motor without ice cubes being pushed into the dispensing chamber 10 as a result and possibly blocking it.

As shown in particular in FIGS. 3, 4 the dispensing chamber 10 essentially has the form of a prone cylinder, on the lateral surface of which a dispensing opening 12 is formed, opening in a downward direction. Opposite this dispensing opening 12 is a through-hole 13, shown in FIG. 1, which extends through an insulation material layer of the door 2 and opens into a recess 14 that opens toward the outside of the door 2. A flap 15 keeps the through-hole 13 closed while the dispenser is not in operation to eject ice through the dispensing opening 12 and the through-hole 13 into a vessel positioned in the recess 14.

A water tank 16 is embedded into the insulating material of the door 2 on the rear wall of the recess 14. The water tank 16 is connected on the one hand like the ice maker 5 by way of a supply line 17 and a check valve 18 to the drinking water network and on the other hand to a tap 19 in the recess 14.

The structure and function of the grinding unit are now described with reference to FIGS. 2 to 4. As shown in FIG. 2, at its end away from the recess 7 the agitator rod 8 merges as a single piece into a cylindrical shaft 20, which extends through the dispensing chamber 10. A distal end segment 21 of the shaft 20 has a non-circular, for example square, cross-sectional form. A sleeve 22 supported on the shaft 20 in such a manner that it can be easily rotated supports a number of knife disks 23, each supporting four knives 9 projecting radially from a round core region 24, as shown in FIG. 3, acting as sliders for ice cubes in the dispensing chamber 10. Sharp-edged plates 26 roughly in the shape of a quarter circle engage in the intermediate spaces between two of the knife disks 23 respectively. Facing edges of the knives 9 and plates 26 are toothed, in order to be able to generate a high local pressure to break up the ice cubes.

The outer peripheries of the parallel plates 26 are connected rigidly to a module by way of two transverse struts 25, 27. In the configuration shown in FIG. 3 the two transverse struts 25, 27 abut against the wall of the dispensing chamber 10 on both sides of the dispensing opening 12, while the plates 26 bridge the dispensing opening 12. The distance between the parallel plates 26 is smaller than the dimensions of the ice cubes produced by the ice maker 5 so that ice cubes in the dispensing chamber 10 cannot pass intact between the plates 26 through the dispensing opening 12.

Edge segments of the plates 26 adjacent to the shaft 20 are clamped respectively by way of elastic buffer rings 29 between two knife disks 23, so that the plates 26 tend to follow a counter-clockwise rotation of the knives 9, if they are not prevented from doing so, as shown in FIG. 3, by a lock 28 abutting against one of the transverse struts 25, 27.

It can also be seen, again with reference to FIG. 2, that the sleeve 22 is supported in a rotatable manner in a support opening 30 formed in an end wall of the dispensing chamber 10 facing toward the door 2. A coupling body 31 is fixed onto the non-circular end segment 21 of the shaft 20 and can be moved with the aid of the electromagnet 11 (not shown in FIG. 2) between the position shown in FIG. 2, in which the sleeve 22 supporting the knives 9 and the shaft 20 can be rotated freely in relation to one another, into a coupling position, in which coupling claws 32 of the sleeve 22 engage in notches 33 in the coupling body 31, with the result that a form fit and force fit are established between the shaft 20 and the sleeve 22.

The mode of operation of the ice dispenser is as follows: as long as the shaft 20 and sleeve 22 are not coupled to one another, as shown in FIG. 2, the motor in the recess 7 is actuated briefly at predetermined time intervals to break up ice cubes that are freezing together in the collector 6 and keep them moving. In the perspective view in FIG. 3 the motor preferably rotates counter-clockwise. A friction torque transmitted by way of the bearing from the shaft 20 to the sleeve 22 does not cause the knife 9 to rotate as said knife 9 is prevented from moving by the plates 26 clamped at the buffer rings 29 and blocked by the lock 28. No ice is crushed and ice cubes in the dispensing chamber 10 do not reach the dispensing opening 12, as they cannot pass through the plates 26.

When the coupling body 31 is displaced, to establish a form fit between shaft 20 and sleeve 22, the knives 9 rotate counter-clockwise together with the agitator rod 8. Ice cubes that reach the dispensing chamber 10 are pushed against the plates 29 by the rotating knives 9 and crushed between the rotating knives 9 and the plates 26 blocked by the lock 28. The resulting fragments pass through the intermediate spaces between the plates 26 and reach the dispensing opening 12. Crushed ice is thus dispensed.

To dispense ice in cubes, it is sufficient to draw the lock 28 back briefly, while the agitator rod 28 is rotated counter-clockwise. Due to the clamping between the buffer rings 29, the module formed by the plates 26 and transverse struts 25, 27 rotates together with the knives 9 and releases the dispensing opening 12. The knives 9 push intact ice cubes to the dispensing opening 12, where they are dispensed.

In principle it is possible, while ice cubes are being dispensed, to have the lock 28 drawn back, so that the plates 26 execute the same rotation as the knives 9. However it is then difficult to measure out the ice cubes, as ice cube dispensing mode can only be terminated again when the plates 26 are back in the position shown in FIG. 3 and are stopped there by the lock 28. In a preferred variant therefore in the transition to ice cube dispensing mode the lock 28 is only drawn back as long as is required for the leading one of the two transverse struts 27 in the direction of rotation to be able to pass the lock 28. When the lock 28 then engages in the dispensing chamber 10 again, it blocks the transverse strut 25 following in the direction of rotation, as shown in FIG. 4, in a position in which the dispensing opening 12 is fully released. To terminate ice cube dispensing mode it is sufficient to move the coupling body 31 away from the sleeve 22 again, so that there is no longer any engagement between the coupling claws 32 and the notches 33. The arrangement of sleeve 22, knives 9, plates 26 and transverse struts 25, 17, which can now be rotated freely again in relation to the shaft 20, is driven by the weight of the plates 26 and the struts 25, 27 to return automatically to the position shown in FIG. 3 corresponding to a stable equilibrium position, in which it is again blocked by the lock 28.

1-9. (canceled)

10. An ice dispenser comprising:
a storage compartment for ice cubes, the storage compartment having a dispensing opening via which ice cubes can exit the storage compartment; and
a slider movable over a dispensing opening of the storage compartment on a predefined path, the slider including a first set of fingers and a module having a second set of fingers, with the first set of fingers being formed of at least two axially interspaced fingers delimiting therebetween an intermediate space, and during movement of the slider on the predefined path, a finger of the second set of fingers passes through the intermediate space between the at least two axially interspaced fingers of the first set of fingers, the module of the slider being movable between a partial covering position in which the module partially covers the dispensing opening and a release position in which the module does not cover the dispensing opening to the same degree as it covers the dispensing opening in its partial covering position.

11. The ice dispenser according to claim 10 wherein one finger of the module is formed as a plate and one edge of the plate bridges the dispensing opening in the partial covering position.

12. The ice dispenser according to claim 10 wherein the slider is configured for rotational movement.

13. The ice dispenser according to claim 12 and further comprising an agitator rotatably disposed in the storage compartment and a coupling disposed between the agitator and the slider to at least one of transmit and not transmit a drive torque exerted on the agitator to the slider, such transmission and lack of transmission being performed as required.

14. The ice dispenser according to claim 13 wherein the agitator and the slider have a common axis of rotation.

15. The ice dispenser according to claim 12 wherein movement of the module between the partial covering position and the release position includes rotation of the module about the axis of rotation of the slider.

16. The ice dispenser according to claim 15 wherein the module is friction-locked to the slider so that the module is carried by rotation of the slider from the partial covering position into the release position.

17. The ice dispenser according to claim 15 wherein the partial covering position is a stable equilibrium position of the module.

18. The ice dispenser according to claim 12 wherein the storage compartment includes a dispensing chamber formed as a cylinder concentric with the axis of rotation of the slider and wherein the dispensing opening is formed on a lateral surface of the cylinder.
